(19) United States
(12) Patent Application Publication
(10) Pub. No.: US 2009/0187483 A1
(43) Pub. Date: Jul. 23, 2009

(54) APPARATUS AND METHOD FOR PROVIDING ADVERTISEMENT IMAGE BASED ON USER INFORMATION

(75) Inventors: Yeong-Mok You, Seongnam-si (KR); Seon-Man Kim, Yongin-si (KR); Bo-Gyeong Kang, Seoul (KR); Seung-Eun Song, Seoul (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/185,249

(22) Filed: Aug. 4, 2008

(30) Foreign Application Priority Data
Jan. 22, 2008 (KR) 2008-6784

(51) Int. Cl. G06Q 30/00

(52) U.S. Cl. 705/14

(57) ABSTRACT

An apparatus and method for providing an advertisement image based on user information, the apparatus including: a selection unit to select an advertisement object, from a plurality of advertisement objects, to be applied to a basic image based on user information; and a playback unit to play back an advertisement image generated after the selected advertisement object is applied to the basic image.

### CROSS-REFERENCE TO RELATED APPLICATION

This application claims the benefit of Korean Patent Application No. 2008-6784, filed Jan. 22, 2008 in the Korean Intellectual Property Office, the disclosure of which is incorporated herein by reference.

### BACKGROUND OF THE INVENTION

1. Field of the Invention

Aspects of the present invention relate to an advertisement image providing apparatus and method, and more particularly, to an apparatus and method for providing advertisement images according to a user.

2. Description of the Related Art

Product placement is a form of advertisement where certain messages or products are advertised through persons or objects. For example, product placement may appear in movies or television (TV) programs, and conventional image synthesis technology may be used for product placement. Specifically, when an advertiser sends advertisement contents to a moving-image provider, the moving-image provider synthesizes the received advertisement contents with an existing image to generate an advertisement image, and provides the advertisement image to a user.

However, while advertisement contents can be synthesized with an existing image by using the conventional image synthesis technology, elements of the existing image cannot be changed. That is, characters or objects cannot be added, deleted, or replaced in the existing image. In addition, an advertisement image that is generated using the conventional image synthesis technology fails to consider characteristics of users who will watch the advertisement image. Therefore, the advertisement image may not be effective for certain users. Consequently, it is difficult to achieve optimal advertising effects.

### SUMMARY OF THE INVENTION

Aspects of the present invention provide an apparatus and method for providing advertising images according to users.

According to an aspect of the present invention, there is provided an advertisement image providing apparatus to play back an advertisement image generated from a basic image according to a user, the advertisement image providing apparatus including: a selection unit to select an advertisement object, from a plurality of advertisement objects, to be applied to the basic image based on user information of the user; and a playback unit to play back the advertisement image generated after the selected advertisement object is applied to the basic image.

According to another aspect of the present invention, there is provided an advertisement image providing method to play back an advertisement image generated from a basic image according to a user, the method including: selecting an advertisement object, from a plurality of advertisement objects, to be applied to the basic image based on user information of the user; and playing back the advertisement image generated after the selected advertisement object is applied to the basic image.

According to another aspect of the present invention, there is provided an advertisement image providing apparatus to generate an advertisement image from a basic image according to a user, the advertisement image providing apparatus including: a selection unit to select an advertisement object, from a plurality of advertisement objects, to be applied to the basic image based on user information of the user; and an advertisement image generating unit to generate the advertisement image by applying the selected advertisement object to the basic image.

According to yet another aspect of the present invention, there is provided an advertisement image providing method to generate an advertisement image from a basic image according to a user, the method including: selecting an advertisement object, from a plurality of advertisement objects, to be applied to the basic image based on user information of the user; and generating the advertisement image by applying the selected advertisement object to the basic image.

According to still another aspect of the present invention, there is provided an advertisement image providing system to generate an advertisement image from a basic image according to a user, the advertisement image providing system including: an advertisement image providing apparatus to generate the advertisement image, the advertisement image providing apparatus including: a selection unit to select an advertisement object, from a plurality of advertisement objects, to be applied to the basic image based on user information of the user, and an advertisement image generating unit to generate the advertisement image by applying the selected advertisement object to the basic image; and a server to store the plurality of advertisement objects.

According to another aspect of the present invention, there is provided an advertisement image providing system to generate an advertisement image from a basic image according to a user, the advertisement image providing system including: a script provider to provide a first script that describes one or more elements of the basic image in an image definition language, such that the basic image is generated based on the first script; an advertisement image providing apparatus to generate the advertisement image, the advertisement image providing apparatus including: a selection unit to select an advertisement object, from a plurality of advertisement objects, to replace a representative word in the first script based on user information of the user, and an advertisement image generating unit to replace the representative word in the first script with the selected advertisement object to create a second script and to generate the advertisement image according to the second script; and a server to store the plurality of advertisement objects.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments, taken in conjunction with the accompanying drawings of which:

FIG. 1 illustrates an advertisement image providing system according to an embodiment of the present invention;

FIG. 2 is a conceptual diagram illustrating an operation of the advertisement image providing apparatus shown in FIG. 1;

FIG. 3 shows examples of representative words according to an embodiment of the present invention;

FIG. 4 illustrates a first script according to an embodiment of the present invention;

FIG. 5 illustrates a basic structure of a rule table according to an embodiment of the present invention;

FIG. 6 illustrates a specific example of the rule table according to an embodiment of the present invention;

FIG. 7 is a block diagram of the advertisement image providing apparatus according to an embodiment of the present invention;

FIG. 8 illustrates an algorithm for downloading an advertisement object according to an embodiment of the present invention;

FIG. 9 is a flowchart illustrating an advertisement image providing method according to an embodiment of the present invention; and

FIG. 10 is a detailed flowchart illustrating operation S960 included in the advertisement image providing method of FIG. 9.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create operations to implement the functions specified in the flowchart block or blocks.

These computer program instructions may also be stored in a computer-usable or computer-readable memory that can direct a computer or other programmable data processing apparatus to function in a particular manner, such that the instructions stored in the computer-usable or computer-readable memory produce an article of manufacture including instruction methods that implement the function specified in the flowchart block or blocks.

The computer program instructions may also be loaded onto a computer or other programmable data processing apparatus to cause a series of operations to be performed on the computer or other programmable apparatus to produce a computer-implemented process such that the instructions that execute on the computer or other programmable apparatus provide operations to implement the functions specified in the flowchart block or blocks.

And each block of the flowchart illustrations may represent a module, segment, or portion of code, which includes one or more executable instructions to implement the specified logical operation(s). It should also be noted that in some alternative implementations, the operations noted in the blocks may occur out of order. For example, two blocks shown in succession may in fact be executed substantially concurrently or the blocks may sometimes be executed in the reverse order, depending upon the functionality involved.

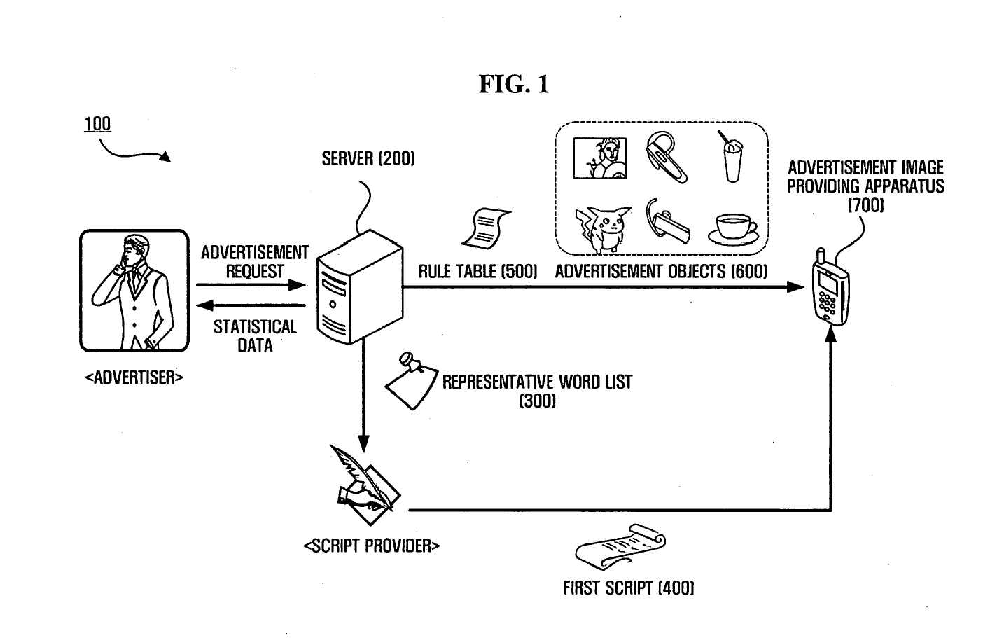

FIG. 1 illustrates an advertisement image providing system 100 according to an exemplary embodiment of the present invention. Referring to FIG. 1, the advertisement image providing system 100 includes a server 200 and an advertisement image providing apparatus 700.

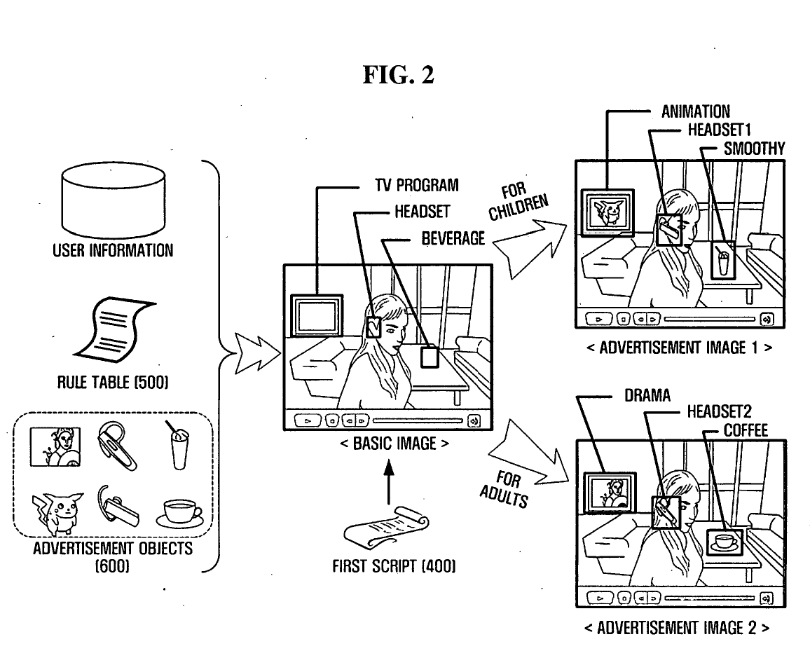

According to aspects of the present invention, the advertisement image providing apparatus 700 selects advertisement objects that are to be applied to a first script 400 for a basic image according to user information. Then, the advertisement image providing apparatus 700 executes a second script created after the selected advertisement objects are applied to the first script 400. Accordingly, an advertisement image appropriate for a specified user is provided on a screen of the advertisement image providing apparatus 700 as shown in FIG. 2.

The first script 400, written by a script provider, describes information regarding elements of the basic image (such as sound, subtitles, characters, and objects) in an image definition language. Furthermore, the first script 400 includes representative words, which represent an advertisement object that can be changed according to user information.

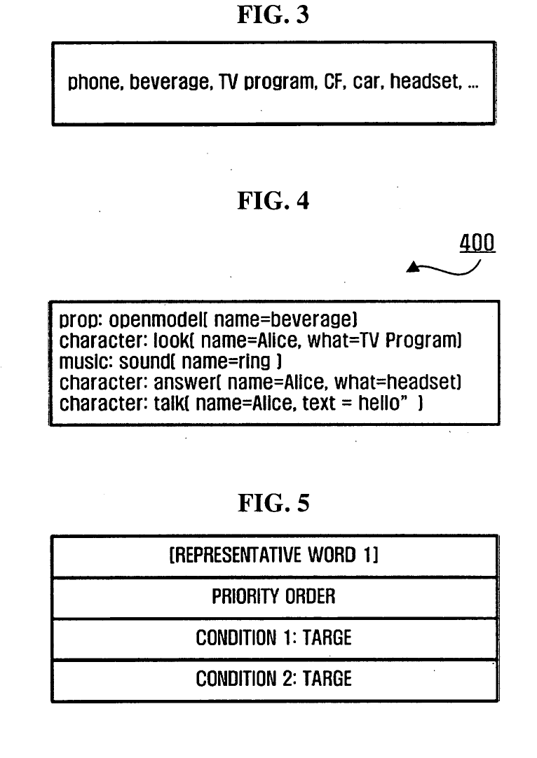

FIG. 3 shows examples of representative words according to an embodiment of the present invention. Referring to FIG. 3, a representative word “beverage” may represent advertisement objects such as coffee and a smoothie. In addition, a representative word “TV program” may represent advertisement objects such as Animation and Drama. Representative words as shown in FIG. 3 may be designated by an advertiser in advance, and stored in the server 200. Accordingly, the script provider writes the first script 400 with reference to a representative word list 300 received from the server 200.

FIG. 4 illustrates a first script 400 according to an embodiment of the present invention. Specifically, FIG. 4 illustrates the first script 400 written by using the representative words of FIG. 3. Referring to FIG. 4, the representative words “beverage,” “TV program,” and “headset” are used in the first script 400 from among the representative words shown in FIG. 3.

Referring back to FIG. 1, the server 200 stores advertisement objects 600 that can be applied to the basic image. In this case, the advertisement objects 600 may be audio data, video data, and/or still image data. The advertisement objects 600 stored in the server 200 are selectively downloaded at the request of the advertisement image providing apparatus 700.

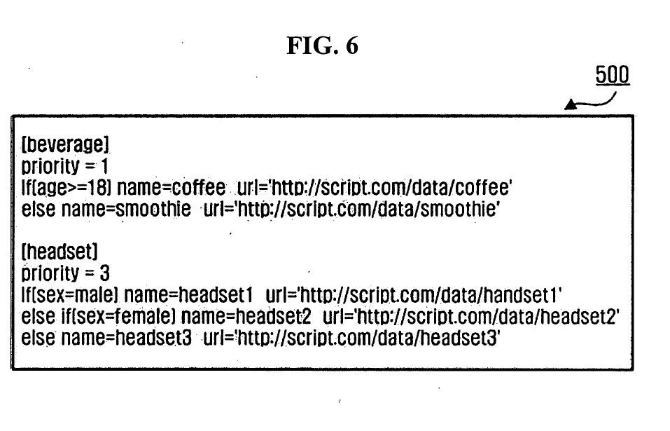

The server 200 stores the representative word list 300 including one or more representative words designated by the advertiser. In addition, the server 200 stores a rule table 500 that specifies rule information of the one or more representative words. The rule information is used to select advertisement objects to be applied to the first script 400 from among the advertisement objects 600. Specifically, the rule information is used to select advertisement objects that correspond to each representative word based on the user information. The rule table 500 will now be described in more detail with reference to FIGS. 5 and 6.

FIG. 5 illustrates a basic structure of the rule table 500 according to an embodiment of the present invention. Referring to FIG. 5, the rule table 500 specifies rule information of one or more of the representative words. For example, the rule table 500 may include the priority order of a specified representative word, a condition, and a target corresponding to the condition. The priority order of the representative word denotes the order in which an advertisement object corresponding to the representative word is applied to the first script 400. In this case, a smaller number indicates a higher priority order, though aspects of the present invention are not limited thereto (for example, a larger number may indicate the higher priority order according to other aspects). The condition determines an advertisement object that will replace the representative word. The target is an advertisement object that will replace the representative word when user information satisfies the condition. The rule information of each representative word may include one or more conditions and one or more targets corresponding to the conditions.

FIG. 6 illustrates a specific example of the rule table 500 according to an embodiment of the present invention. Rule information of the representative word “beverage” and that of the representative word “headset” from among the representative words shown in FIG. 3 are included in the rule table 500 of FIG. 6.

Referring to FIG. 6, the priority order of the representative word “beverage” is one. In addition, “coffee” is allocated as an advertisement object that will replace the representative word “beverage” if a user is aged 18 years or over (condition 1), as illustrated in FIG. 2. On the other hand, “smoothie” is allocated as the advertisement object that will replace the representative word “beverage” if the user is aged under 18 years (condition 2), as illustrated in FIG. 2.

The priority order of the representative word “headset” is three. In addition, “headset1” is allocated as an advertisement object that will replace the representative word “headset” if the user is male (condition 1). On the other hand, “headset2” is allocated as the advertisement object that will replace the representative word “headset” if the user is female (condition 2). If the gender of the user is not known (condition 3), “headset3” is allocated as the advertisement object that will replace the representative word “headset.”

As can be seen in FIG. 6, the priority order of the representative word “beverage” is higher than that of the representative word “headset.” Thus, if both of the representative words “beverage” and “headset” are used in the first script 400, the advertisement object corresponding to the representative word “beverage” is first provided to the advertisement image providing apparatus 700. The rule table 500 described above may be created by an advertiser.

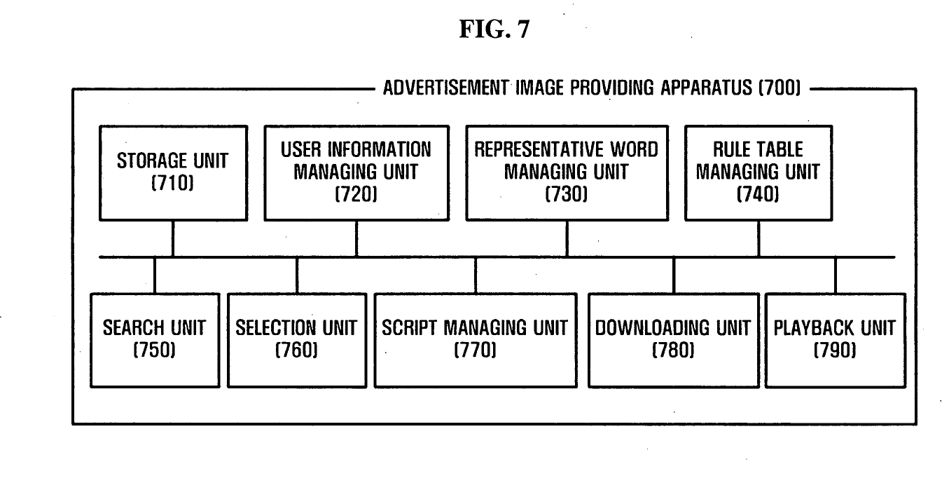

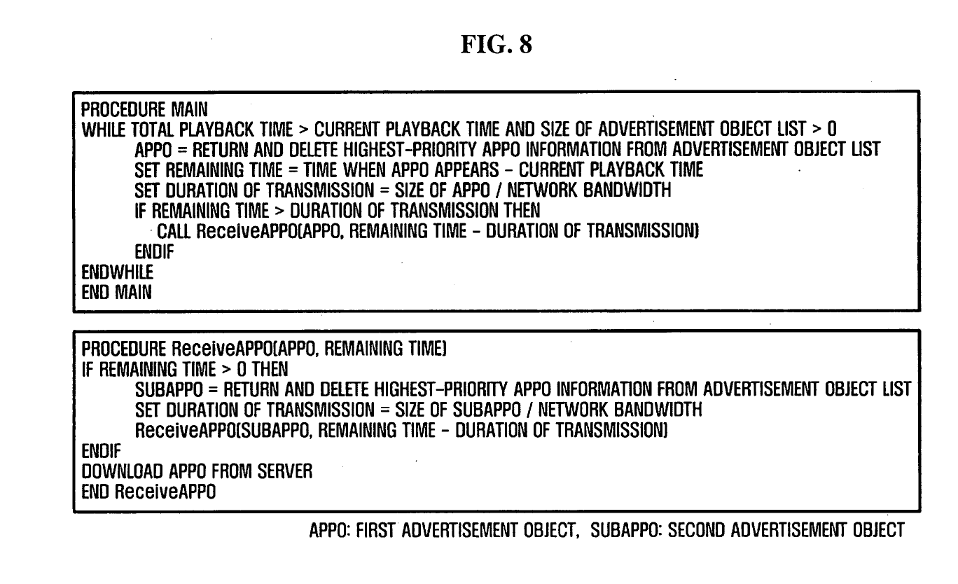

The advertisement image providing apparatus 700 will now be described in detail with reference to FIGS. 7 and 8.

FIG. 7 is a block diagram of an advertisement image providing apparatus 700 according to an embodiment of the present invention. Referring to FIG. 7, the advertisement image providing apparatus 700 includes a storage unit 710, a user information managing unit 720, a representative word managing unit 730, a rule table managing unit 740, a search unit 750, a selection unit 760, a script managing unit 770, a downloading unit 780, and a playback unit 790.

The storage unit 710 stores data used to generate an advertisement image. For example, the storage unit 710 may store the first script 400 provided by a script provider, the representative word list 300 provided by the server 200, and the rule table 500 provided by the server 200. The storage unit 710 may be, but is not limited to, a nonvolatile memory device (such as a cache, a read-only memory (ROM), a programmable read-only memory (PROM), an erasable programmable read-only memory (EPROM), an electrically erasable programmable read-only memory (EEPROM) and a flash memory), or a volatile memory device (such as a random access memory (RAM)).

The user information managing unit 720 manages user information. Examples of the user information include a user's gender, age, place of residence, language, hobby, and information regarding the user's terminal. In this case, the user's terminal may be a digital device that includes part or all of the components of the advertisement image providing apparatus 700. Furthermore, examples of the information regarding the user's terminal include software information (such as an operating system (OS)) and hardware information (such as network bandwidth, a central processing unit (CPU), a memory, and display resolution). The user information may be stored in the storage unit 710 described above, and the user information managing unit 720 may update the stored user information in response to a user command or automatically update the stored user information at predetermined intervals.

The representative word managing unit 730 manages the representative word list 300. For example, if a representative word list 300 received from the server 200 includes new representative words, the representative word managing unit 730 adds the new representative words to the representative word list 300 stored in the storage unit 710. The representative word list 300 managed by the representative word managing unit 730 is used when the search unit 750, which will be described later, searches the first script 400 for representative words.

The rule table managing unit 740 manages the rule table 500 of each representative word. For example, the rule table managing unit 740 may receive the rule table 500 of a specified representative word from the server 200. In this case, if a rule table of the specified representative word already exists, the rule table managing unit 740 may combine the rule table 500 received from the server 200 with the existing rule table or replace the existing rule table with the rule table 500 received from the server 200.

The search unit 750 searches the first script 400 for representative words with reference to the representative word list 300. After finding the representative words in the first script 400, the search unit 750 retrieves rule information of the found representative words from the stored rule table 500. For example, if the search unit 750 finds the representative words “beverage” and “headset” in the first script 400, the search unit 750 retrieves the rule information of “beverage” and that of “headset” from the stored rule table 500. The rule information retrieved by the search unit 750 is provided to the selection unit 760.

The selection unit 760 selects advertisement objects to replace the representative words of the first script 400 based on the rule information provided by the search unit 750 and the user information. Specifically, the selection unit 760 selects a target, which corresponds to a condition that matches the user information from among conditions included in the received rule information, as an advertisement object to replace a corresponding representative word. For example, the first script 400 may include the representative word “beverage,” and the rule information of the representative word “beverage” may be as shown in FIG. 5. In this case, if the user information indicates that a user is 15 years old, the selection unit 760 selects smoothie as the advertisement object to replace the representative word “beverage” in the first script 400. Information regarding advertisement objects selected by the selection unit 760 is provided to the script managing unit 770.

The script managing unit 770 modifies the first script 400 and creates the second script. Specifically, the script managing unit 770 replaces the representative words of the first script 400 with advertisement objects selected by the selection unit 760 and creates the second script. The created second script is then provided to the playback unit 790.

The downloading unit 780 downloads, from the server 200, the advertisement objects selected by the selection unit 760. According to an aspect of the present invention, the downloading unit 780 downloads all of advertisement objects before the second script is executed. However, it is understood that aspects of the present invention are not limited thereto. For example, according to other aspects, the downloading unit 780 downloads some or all of the advertisement objects while the second script is executed. For example, the downloading unit 780 may download high-priority advertisement objects before the second script is executed and download lower-priority advertisement objects while the second script is being executed. Alternatively, the downloading unit 780 may download all of the advertisement objects while the second script is being executed.

In order to download advertisement objects while the second script is being executed, the downloading unit 780 may refer to related information of each advertisement object. Examples of the related information include a position of a specified advertisement object in the server 200, the priority order of the advertisement object, a total execution time of the second script, the time when the advertisement object first appears in the second script, and the size of the advertisement object. The process of downloading a specified advertisement object with reference to the related information of the advertisement object will now be described in more detail. First, the downloading unit 780 selects a first advertisement object with the highest priority order from advertisement objects that are to be downloaded. Then, the downloading unit 780 calculates the time left before the first advertisement object first appears in the second script and the time required to transmit the first advertisement object. The time left before the first advertisement object first appears in the second script may be calculated by subtracting a current time by which the second script has been executed from a time when the first advertisement object first appears in the second script. The time to transmit the first advertisement object may be calculated by dividing the size of the first advertisement object by network bandwidth.

If the time left before the first advertisement object first appears in the second script is longer than the time required to transmit the first advertisement object, the downloading unit 780 may download the first advertisement object. In addition, the downloading unit 780 may download a second advertisement object with the next highest priority order during a period of time calculated by subtracting the time required to transmit the first advertisement object from the time left before the first advertisement object first appears in the second script. The above algorithm for downloading an advertisement object may be as illustrated in FIG. 8.

FIG. 8 illustrates an algorithm for downloading an advertisement object according to an embodiment of the present invention. Referring to the algorithm illustrated in FIG. 8, network bandwidth is periodically measured by the downloading unit 780. The time intervals at which the downloading unit 780 measures the network bandwidth may vary according to the manner in which the downloading unit 780 and the server 200 communicate with each other. That is, if the downloading unit 780 and the server 200 communicate with each other in a wired manner, the network bandwidth may be measured, for example, every ten minutes. If the downloading unit 780 and the server 200 communicate with each other in a wireless manner, the network bandwidth may be measured, for example, every minute. Advertisement objects downloaded using the algorithm of FIG. 8 may be stored in the storage unit 710 described above.

Referring back to FIG. 7, the playback unit 790 executes the second script. In this case, executing the second script generates an advertisement image by combining audio data and/or image data based on the second script and playing back the generated advertisement image.

As used herein, the term “play back” denotes visually or acoustically representing an advertisement object so that a user can perceive (i.e., see and/or hear) the advertisement object. Examples of the playback type of the advertisement object include “Play” and “Display.” “Play” represents an advertisement image in an audio/video format. For example, if the advertisemnt image is a moving image or music, the playback type of the advertisement image may be “Play.” In addition, “Display” is to present an advertisement image on a visual device.

While executing the second script, the playback unit 790 may determine whether a specified advertisement object included in the second script has been downloaded. If the advertisement object has been downloaded, the playback unit 790 connects the downloaded advertisement object to the second script. If the advertisement object has not been downloaded, the playback unit 790 may connect a pre-stored alternative object to the second script or execute instructions to download the advertisement object.

While the playback unit 790 is executing the second script by connecting the downloaded advertisement object or the pre-stored alternative object to the second script, if the execution of the second script is arbitrarily or normally terminated, the playback unit 790 may transmit playback log information of the played-back advertisement object to the server 200. In this case, the playback log information of the played-back advertisement object may include the playback time of the advertisement object and the number of times that the advertisement object has been played back. Accordingly, the playback log information transmitted to the server 200 may be used by an advertiser to analyze advertising effects or used as marketing or billing data.

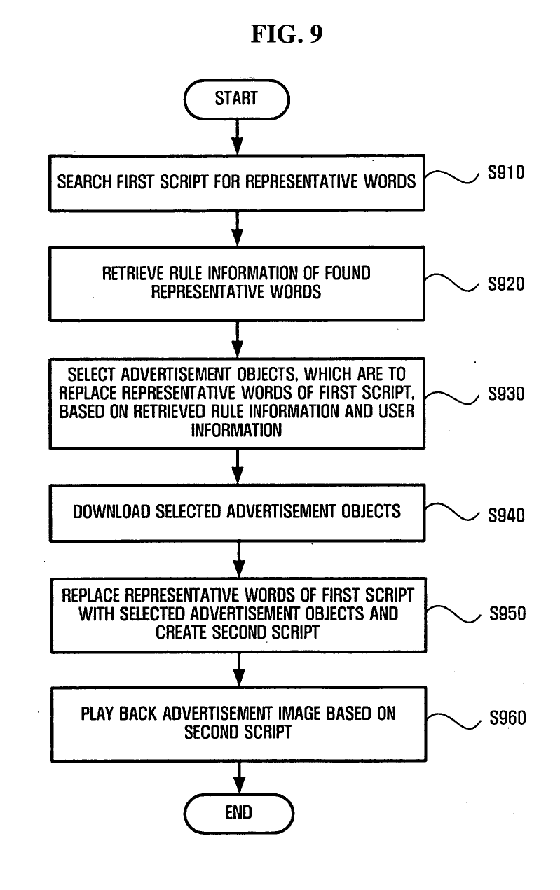

FIG. 9 is a flowchart illustrating an advertisement image providing method according to an embodiment of the present invention. Referring to FIG. 9, when a script provider provides the first script 400 for a basic image, the first script 400 is searched based on the representative word list 300 received from the server 200 in order to find representative words in the first script 400 in operation S910.

Once the representative words of the first script 400 are found (operation S910), rule information of the representative words is retrieved from the pre-stored rule table 500 in operation S920. For example, if a representative word “beverage” is found in the first script 400, the rule information of the representative word “beverage” as shown in FIG. 5 is retrieved.

Next, advertisement objects that are to replace the representative words in the first script 400 are selected based on the retrieved rule information and user information in operation S930. The selecting of the advertisement objects may include comparing conditions included in the retrieved rule information with the user information and selecting a target according to a condition that matches the user information from among the conditions as an advertisement object to replace each representative word in the first script 400.

If the advertisement objects to replace the representative words of the first script 400 are selected (operation S930), the selected advertisement objects are downloaded with reference to related information of the selected advertisement objects in operation S940. Then, the representative words of the first script 400 are replaced by the selected advertisement objects to create the second script in operation S950.

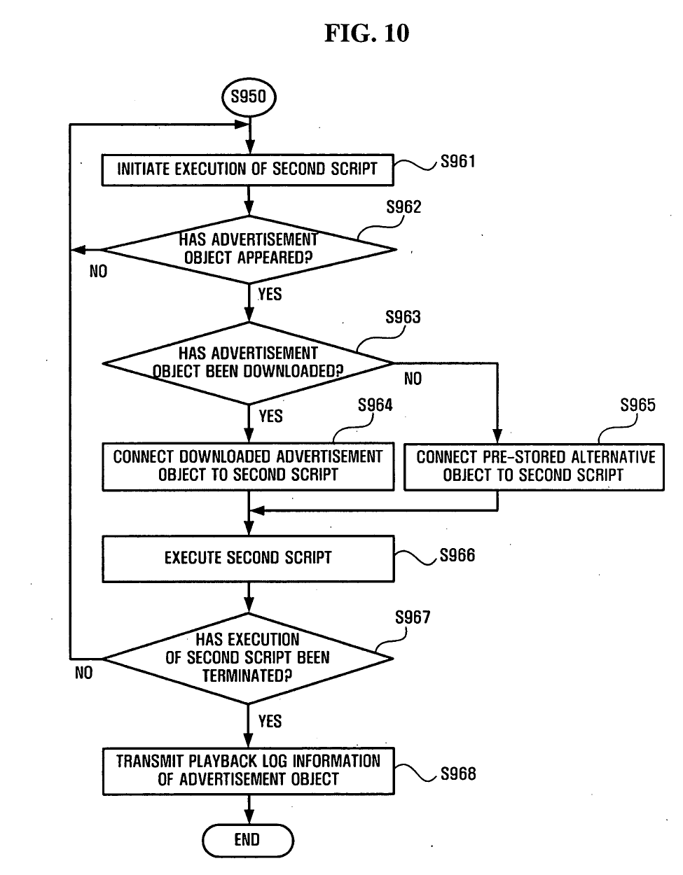

Once the second script is created (operation S950), the created second script is executed. That is, audio data and image data is combined based on the second script to generate an advertisement image, and the generated advertisement image is played back in operation S960. Operation S960 will be described later in more detail with reference to FIG. 10.

It is understood that in the above advertisement image providing method, operation S940, in which the selected advertisement objects are downloaded, and operation S960, in which the advertisement image based on the second script is played back, may be performed sequentially or simultaneously.

FIG. 10 is a detailed flowchart illustrating operation S960 included in the advertisement image providing method of FIG. 9. Referring to FIG. 10, after the execution of the second script is initiated in operation S961, if a specified advertisement object appears in the second script (operation S962), it is determined whether the advertisement object has been downloaded in operation S963.

If it is determined that the advertisement object has been downloaded (operation S963), the downloaded advertisement object is connected to the second script in operation S964. If it is determined that the advertisement object has not been downloaded (operation S963), a pre-stored alternative object is connected to the second script in operation S965.

While the second script is continuously executed in operation S966, it is determined whether the execution of the second script has been terminated in operation S967. If it is determined that the execution of the second script has not been terminated (operation S967), operations S961 through 966 are repeated. If it is determined that the execution of the second script has been terminated (operation S967), playback log information of the advertisement object is transmitted to the server 200 in operation S968.

Each element of the advertisement image providing apparatus 700 described above may be implemented as a kind of module. The term module, as used herein, refers to, but is not limited to, a software and/or hardware component, such as a Field Programmable Gate Array (FPGA) or Application Specific Integrated Circuit (ASIC), which performs certain tasks. A module may be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they are executed by one or more computers in a communication system.

With this in mind, and in addition to the above described embodiments, aspects of the present invention can also be implemented through computer-readable code/instructions in/on a medium (e.g., a computer readable medium), to control at least one processing element to implement any above described embodiment. The medium can correspond to any medium/media permitting the storing and/or transmission of the computer readable code.

The computer-readable code can be recorded/transferred on a medium in a variety of ways, with examples of the medium including recording media such as magnetic storage media (e.g., ROM, floppy disks, hard disks, etc.) and optical recording media (e.g., CD-ROMs, or DVDs). The media may also be a distributed network, so that the computer readable code is stored/transferred and executed in a distributed fashion. Aspects of the present invention may also be realized as a data signal embodied in a carrier wave and comprising a program readable by a computer and transmittable over the Internet Still further, as only an example, the processing element could include a processor or a computer processor, and processing elements may be distributed and/or included in a single device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An advertisement image providing apparatus to play back an advertisement image generated from a basic image according to user information, the advertisement image providing apparatus comprising:
a selection unit to select an advertisement object, from a plurality of advertisement objects, to be applied to the basic image based on the user information; and
a playback unit to play back the advertisement image generated after the selected advertisement object is applied to the basic image.

2. The apparatus as claimed in claim 1, wherein:
the user information comprises a user's gender, the user's age, the user's place of residence, the user's language, the user's hobby, and/or information regarding the user's terminal; and
the information regarding the user's terminal comprises an operating system (OS) of the user's terminal, a network bandwidth of the user's terminal, a central processing unit (CPU) of the user's terminal, a memory of the user's terminal, and/or a display resolution of the user's terminal.

3. The apparatus as claimed in claim 1, wherein:
the basic image is generated based on a first script that describes information regarding one or more elements of the basic image in an image definition language;
the first script comprises a representative word to be replaced by the selected advertisement object; and
the advertisement image is generated according to a second script that is created after the representative word in the first script is replaced by the selected advertisement object.

4. The apparatus as claimed in claim 3, wherein the one or more elements of the basic image comprise sound, subtitles, characters, and/or objects.

5. The apparatus as claimed in claim 3, wherein:
the selection unit selects the advertisement object corresponding to a condition for determining the advertisement object; and
the condition is included in rule information of the representative word.

6. The apparatus as claimed in claim 5, wherein the rule information of the representative word comprises a priority order of the representative word such that the representative word is replaced with the advertisement object before or after another replacement word is replaced by another advertisement object according to the priority order.

7. The apparatus as claimed in claim 3, further comprising a downloading unit to download the selected advertisement object based on related information of the selected advertisement object.

8. The apparatus as claimed in claim 7, wherein the related information of the selected advertisement object comprises a position of the selected advertisement object in a server, a size of the selected advertisement object, a priority order of the selected advertisement object, a time when the selected advertisement object first appears in the second script, a total execution time of the second script, and/or a time required to download the selected advertisement object.

9. The apparatus as claimed in claim 7, wherein the downloading unit downloads the selected advertisement object while the second script is executed.

10. The apparatus as claimed in claim 3, wherein the playback unit connects the selected advertisement object to the second script if the selected advertisement object is stored and connects a pre-stored alternative object to the second script if the selected advertisement object is not stored.

11. The apparatus as claimed in claim 1, wherein the playback unit transmits playback log information of the selected advertisement object to a server, the playback log information of the selected advertisement object comprising a playback time of the selected advertisement object and/or a number of times that the selected advertisement object has been played back.

12. An advertisement image providing method to play back an advertisement image generated from a basic image according to user information, the method comprising:
selecting an advertisement object, from a plurality of advertisement objects, to be applied to the basic image based on the user information;
generating the advertisement image by applying the selected advertisement object to the basic image; and
playing back the generated advertisement image.

13. The method as claimed in claim 12, wherein:
the user information comprises a user's gender, the user's age, the user's place of residence, the user's language, the user's hobby, and/or information regarding the user's terminal; and
the information regarding the user's terminal comprises an OS of the user's terminal, a network bandwidth of the user's terminal, a CPU of the user's terminal, a memory of the user's terminal, and a display resolution of the user's terminal.

14. The method as claimed in claim 12, wherein:
the basic image is generated based on a first script that describes information regarding one or more elements of the basic image in an image definition language;
the first script comprises a representative word to be replaced by the selected advertisement object; and
the generating of the advertisement image comprises:
replacing the representative word in the first script with the selected advertisement object to create a second script, and
generating the advertisement image according to the second script.

15. The method as claimed in claim 14, wherein the one or more elements of the basic image comprise sound, subtitles, characters, and/or objects.

16. The method as claimed in claim 14, wherein the selecting of the advertisement object comprises selecting the advertisement object corresponding to a condition for determining the advertisement object, the condition being included in rule information of the representative word.

17. The method as claimed in claim 16, wherein the rule information of the representative word comprises a priority order of the representative word such that the representative word is replaced with the advertisement object before or after another replacement word is replaced by another advertisement object according to the priority order.

18. The method as claimed in claim 14, further comprising downloading the selected advertisement object based on related information of the selected advertisement object.

19. The method as claimed in claim 18, wherein the related information of the selected advertisement object comprises a position of the selected advertisement object in a server, a size of the selected advertisement object, a priority order of the selected advertisement object, a time when the selected advertisement object first appears in the second script, a total execution time of the second script, and/or a time required to download the selected advertisement object.

20. The method as claimed in claim 18, wherein the downloading of the selected advertisement object comprises downloaded the selected advertisement object while the second script is executed.

21. The method as claimed in claim 14, wherein the playing back of the advertisement image comprises connecting the selected advertisement object to the second script if the selected advertisement object is stored and connecting a pre-stored alternative object to the second script if the selected advertisement object is not stored.

22. The method as claimed in claim 12, further comprising transmitting playback log information of the selected advertisement object to a server, the playback log information of the selected advertisement object comprising a playback time of the selected advertisement object and/or a number of times that the selected advertisement object has been played back.

23. A computer readable recording medium encoded with the method of claim 12 and implemented by a computer.

24. An advertisement image providing apparatus to generate an advertisement image from a basic image according to user information, the advertisement image providing apparatus comprising:
a selection unit to select an advertisement object, from a plurality of advertisement objects, to be applied to the basic image based on the user information; and
an advertisement image generating unit to generate the advertisement image by applying the selected advertisement object to the basic image.

25. The apparatus as claimed in claim 24, further comprising a playback unit to play back the advertisement image.

26. The apparatus as claimed in claim 24, wherein:
the basic image is generated based on a first script that describes information regarding one or more elements of the basic image in an image definition language;
the first script comprises a representative word to be replaced by the selected advertisement object; and
the advertisement image generating unit replaces the representative word in the first script with the selected advertisement object to create a second script and generates the advertisement image according to the second script.

27. The apparatus as claimed in claim 26, wherein:
the selection unit selects the advertisement object corresponding to a condition for determining the advertisement object; and
the condition is included in rule information of the representative word.

28. The apparatus as claimed in claim 27, wherein the rule information of the representative word comprises a priority order of the representative word such that the representative word is replaced with the advertisement object before or after another replacement word is replaced by another advertisement object according to the priority order.

29. The apparatus as claimed in claim 26, further comprising a downloading unit to download the selected advertisement object based on related information of the selected advertisement object.

30. An advertisement image providing method to generate an advertisement image from a basic image according to user information, the method comprising:
selecting an advertisement object, from a plurality of advertisement objects, to be applied to the basic image based on the user information; and
generating the advertisement image by applying the selected advertisement object to the basic image.

31. The method as claimed in claim 30, wherein:
the basic image is generated based on a first script that describes information regarding one or more elements of the basic image in an image definition language;
the first script comprises a representative word to be replaced by the selected advertisement object; and
the generating of the advertisement image comprises:
replacing the representative word in the first script with the selected advertisement object to create a second script, and
generating the advertisement image according to the second script.

32. The method as claimed in claim 31, wherein the selecting of the advertisement object comprises selecting the advertisement object corresponding to a condition for determining the advertisement object, the condition being included in rule information of the representative word.

33. A computer readable recording medium encoded with the method of claim 30 and implemented by a computer.
